(19) United States
(12) Patent Application Publication
(10) Pub. No.: US 2021/0221053 A1
(43) Pub. Date: Jul. 22, 2021

(54) BUILD MATERIAL OR PRINTING AGENT SELECTION IN A 3D PRINTING SYSTEM

(71) Applicant: HEWLETT-PACKARD DEVELOPMENT COMPANY, L.P., Houston, TX (US)

(72) Inventors: Alejandro Manuel De Pena, Sant Cugat del Valles (ES); Luis Garcia Garcia, Sant Cugat del Valles (ES); Pol Fornos, Sant Cugat del Valles (ES)

(73) Assignee: HEWLETT-PACKARD DEVELOPMENT COMPANY, L.P., Houston, TX (US)

(21) Appl. No.: 16/095,851

(22) PCT Filed: Jul. 12, 2016
(86) PCT No.: PCT/EP2016/066566

§ 371 Date: Oct. 23, 2018

(51) Int. Cl. B29C 64/165; B33Y 10/00; B33Y 30/00

(52) U.S. Cl. CPC B29C 64/165; B33Y 30/00; B33Y 10/00

(57) ABSTRACT

A three-dimensional object is generated using a build material and a printing agent. A visible property of one of the build material and the printing agent is identified. The other of the build material and the printing agent is selected based at least on the other of the build material and the printing agent having a given visible property. A three-dimensional object is generated using the one of build material and the printing agent having the identified visible property and the other of the build material and the printing agent having the given visible property. The selecting is based at least on the identified visible property and the given visible property having a desired visible property relationship. An apparatus for building a three-dimensional object is also disclosed.

### BACKGROUND

Additive manufacturing systems, including those commonly referred to as “3D printers” build three-dimensional (3D) objects from selective addition of build material. In an example system, build material is formed in layers in a working area. Chemical agents, referred to herein as “printing agents”, may be then selectively deposited onto each layer within the working area. In one case, the printing agents may comprise a fusing agent and a detailing agent. In this case, the fusing agent is selectively applied to a layer in areas where particles of the build material are to fuse together, and the detailing agent is selectively applied where the fusing action is to be reduced. For example, a detailing agent may be applied to reduce fusing at an object boundary to produce a part with sharp and smooth edges. Following the application of printing agents, fusing energy is applied to the layer. This fuses particles of build material on which fusing agent was applied. The process is then repeated for another layer, such that objects are built from a series of cross-sections.

### BRIEF DESCRIPTION OF THE DRAWINGS

Various features of the present disclosure will be apparent from the detailed description which follows, taken in conjunction with the accompanying drawings, which together illustrate features of certain examples, and wherein:

FIG. 1 is a schematic diagram showing components of an additive manufacturing system according to an example;

FIG. 2 is a schematic diagram showing components of an additive manufacturing system according to another example;

FIG. 3 is a schematic diagram showing components of part of an additive manufacturing system according to an example;

FIG. 4 is a schematic diagram showing components of part of an additive manufacturing system according to another example;

FIG. 5 is a flowchart showing a method of generating a three-dimensional object according to an example;

FIG. 6 is a table showing results of different combinations of build material and printing agent according to an example;

FIG. 7 is a schematic diagram showing a consumable unit according to an example;

FIG. 8 is a flowchart showing a method of manufacturing a consumable unit according to an example; and

FIG. 9 is a schematic diagram showing a set of computer-readable instructions within a non-transitory computer-readable storage medium according to an example.

### DETAILED DESCRIPTION

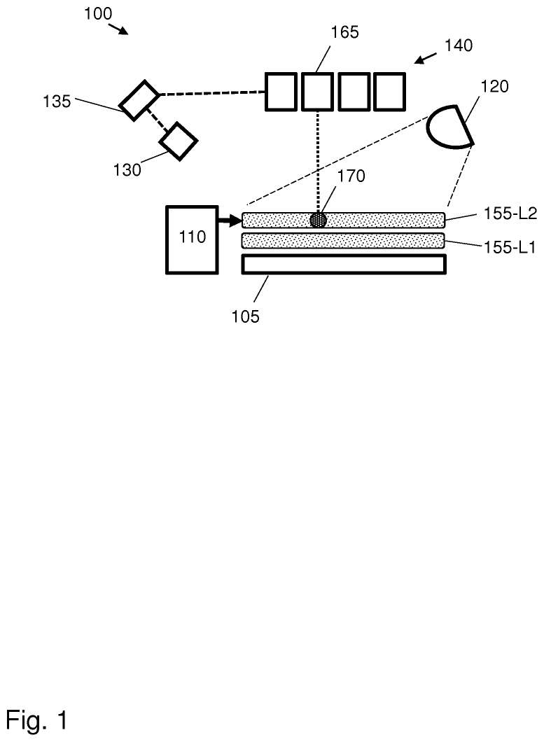

Referring to FIG. 1, there is shown an example of an additive manufacturing system 100. Although the example additive manufacturing system 100 is provided to better understand the context of the examples described herein, those examples may be applied to a variety of additive manufacturing systems including, amongst others, other agent printing-based systems.

In this example, the additive manufacturing system 100 comprises a build platform 105. In this example, the additive manufacturing system 100 comprises a supply mechanism 110 to form a base of build material upon the build platform 105. In this example, the additive manufacturing system 100 comprises one or more radiation sources 120 to heat a layer of build material. In this example, the additive manufacturing system 100 comprises a thermal sensor 130 to measure a thermal profile of the base. In this example, the additive manufacturing system 100 comprises a controller 135. In this example, the additive manufacturing system 100 comprises a printing agent deposit mechanism 140. The printing agent deposit mechanism 140 applies at least one printing agent. Examples of printing agent include, but are not limited to, fusing agents and binding agents.

The features shown in FIG. 1 may be used to produce both a base for additive manufacturing and one or multiple three-dimensional objects upon the base. For example, the supply mechanism 110 may be configured to supply at least one build material layer. This may form a layer of the base or an object to be produced. At least one printing agent may be deposited on one or more of the layers by the printing agent deposit mechanism 140. In this example, the supply mechanism 110 supplies a powdered build material in successive layers. Two layers are shown in FIG. 1: a first layer 155-L1 upon which a second layer 155-L2 has been formed by the supply mechanism 110. The supply mechanism 110 may be arranged to move relative to the build platform 105 such that successive layers are formed on top of each other.

The one or more radiation sources 120 may comprise a lamp, for example a short-wave incandescent or infrared lamp. The one or more radiation sources 120 may be another light source constructed to emit electromagnetic radiation across a range of wavelengths to heat the base. For example, the radiation source 120 may be a halogen lamp. The additive manufacturing system 100 may comprise one radiation source to heat the base or may comprise a plurality of radiation sources to heat the base. Radiation sources may have other uses. For example, radiation sources may comprise lighting systems to illuminate the working area or to fuse a build material.

An infrared “pre-heat” lamp may be used to heat the base. The pre-heat lamp may be located above the build platform 105, for example such that it heats at least an upper surface of the base. The pre-heat lamp may be controlled to heat the base to a temperature just below a melting point of the build material. Another radiation source may then be used during construction of a 3D object. For example, in one implementation, a separate fusing lamp may be used. The fusing lamp may apply energy to cause fusing of build material on which a fusing agent has been applied.

The thermal sensor 130 may be configured to measure a thermal profile of the base. The thermal profile may comprise a two-dimensional representation of the temperature of an upper surface of the base. The thermal sensor 130 may comprise a thermal imaging camera. The thermal imaging camera may comprise one or more infrared sensors. The thermal sensor 130 may comprise an array of thermopiles and an optical system such that the infrared sensor is an infrared camera. The optical system may comprise a system of lenses such that an infrared image is formed by the infrared camera. In such an example, each thermopile may return a value representative of radiation integrated within its spectral window.

The printing agent deposit mechanism 140 may comprise at least one print head 165 to deposit a printing agent. The printing agent deposit mechanism 140 may deposit different types of fluid printing agent, for example a fusing agent and a detailing agent. The fusing agent may be used to increase heating of the base. The detailing agent may be used to decrease heating of the base. For example, the printing agent deposit mechanism 140 may comprise an ‘inkjet’ deposit mechanism for printing a plurality of printing agents onto layers of powdered build material 155. A print head may be adapted to deposit one or multiple printing agents onto layers of powdered polymer build material that form the base. Print heads within the deposit mechanism may be arranged to deposit a particular printing agent upon defined areas within a plurality of successive build material layers.

A fusing agent (sometimes also referred to as a “coalescing agent”) may increase heating of portions of the layer on which it has been printed by acting as an energy absorbing agent that causes build material on which it has been deposited to absorb more energy, for example from the radiation source 120, than build material on which no fusing agent has been deposited. This may cause build material to heat up. When heating the layer, a desired temperature for the layer may be below a fusing temperature of the build material. Hence, application of fusing agent causes heating of the layer but does not cause melting and fusing of the build material. However, when constructing a 3D object, build material may be heated above the fusing temperature, and the fusing agent may act to cause the build material to melt, coalesce or fuse, and then solidify after cooling. In this manner, solid parts of the 3D object may be constructed. A fusing agent is different from a binding material (or “binder”) in that a fusing agent acts as an energy absorbing agent that causes build material on which it has been deposited to absorb more energy, whereas a binding material or binder chemically acts to draw build material together to form a cohesive whole.

A detailing agent (sometimes also referred to as a “modifying agent” or “modifier”) may act to modify the effect of a fusing agent and/or act directly to cool build material. When heating a layer, a detailing agent may thus be applied to reduce a heating effect of previously applied fusing agent and/or to directly reduce the temperature of the build material. When constructing a 3D object, a detailing agent may be used to form sharp object edges by inhibiting a fusing agent outside of an object boundary and thus preventing solidification in exterior areas of a cross-section. During construction of an object, a detailing agent may also be used to prevent thermal bleed from a fused area to a non-fused area and to prevent fusing in “blank” or “empty” portions of an object, for example in internal cavities. At the end of production of an object, unfused build material may be removed to reveal the completed object.

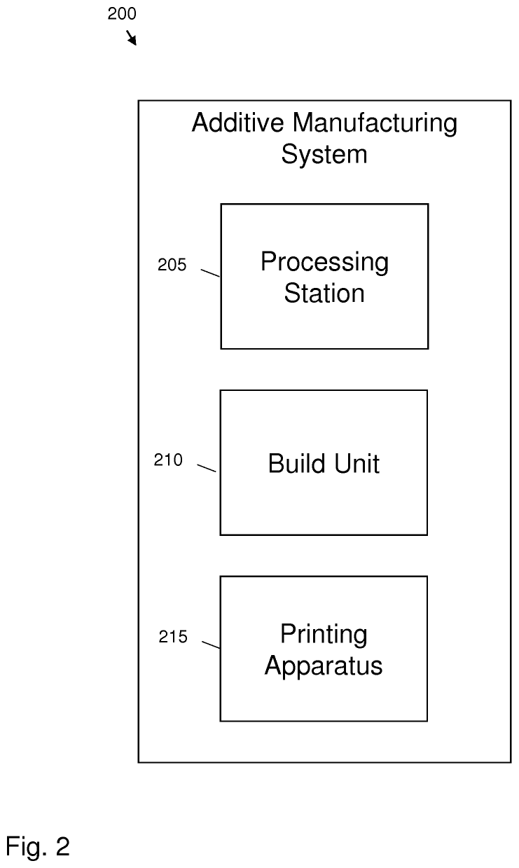

Referring to FIG. 2, there is shown example of an additive manufacturing system 200.

In this example, the additive manufacturing system 200 comprises a processing station 205, a build unit 210 and a printing apparatus 215. The processing station 205 may be used to load build material into the build unit 210. For example, one or more cartridges comprising build material may be inserted into the processing station 205 and the processing station 205 may load build material, for example from the one or more cartridges, into the build unit 210. The build unit 210 may be removed from the processing station 205 and slotted or otherwise inserted into the printing apparatus 215, thereby moving the build material loaded into the build unit 210 by the processing station 205 into the printing apparatus 215. The printing apparatus 215 may use printing agents that have been loaded into the printing apparatus 215, along with the build material in the build unit 210, to produce a three-dimensional object on the build unit 210. The build unit 210 may be removed from the printing apparatus 215 and slotted back into the processing station 205. The processing station 205 may for example aid cooling of the three-dimensional object produced in the printing apparatus 215.

In examples described herein, one or more colour properties of a three-dimensional object may be enhanced. For example, the colour uniformity of the three-dimensional object may be enhanced. This, in turn, may enhance the aesthetic appeal of the three-dimensional object and/or may enhance monitoring or feedback processes as described in more detail below.

In examples described herein, a visible property of one of the build material and the printing agent may be matched with a visible property of the other of the build material and the printing agent. For example, the colour of the build material, for example powder supply, may be matched with the colour of the printing agent, for example binding agent and/or fusing agent. This may result in improved aesthetics of a 3D object generated using such build material and printing agent. By reducing the contrast, or colour difference, between coloured build material and coloured print agents, the look, or aesthetics, of the final 3D part may be improved. By reducing the contrast, or colour difference, between coloured build material and coloured print agents, colour uniformity of the final 3D part may be improved. Improving colour uniformity may help to reduce mischaracterisation of colour differences in 3D objects as defects of the manufacturing process, for example by computer-controlled monitoring or feedback processes. For example, having a more uniform colour profile may help to reduce mischaracterisation of parts of the 3D object as having shadows (potentially indicating an undesired surface feature) where those parts resulted from a degree of lack of colour uniformity rather than an undesired surface defect. The techniques described herein may also allow single-colour parts, resembling single-colour parts produced by injection-molding, to be made.

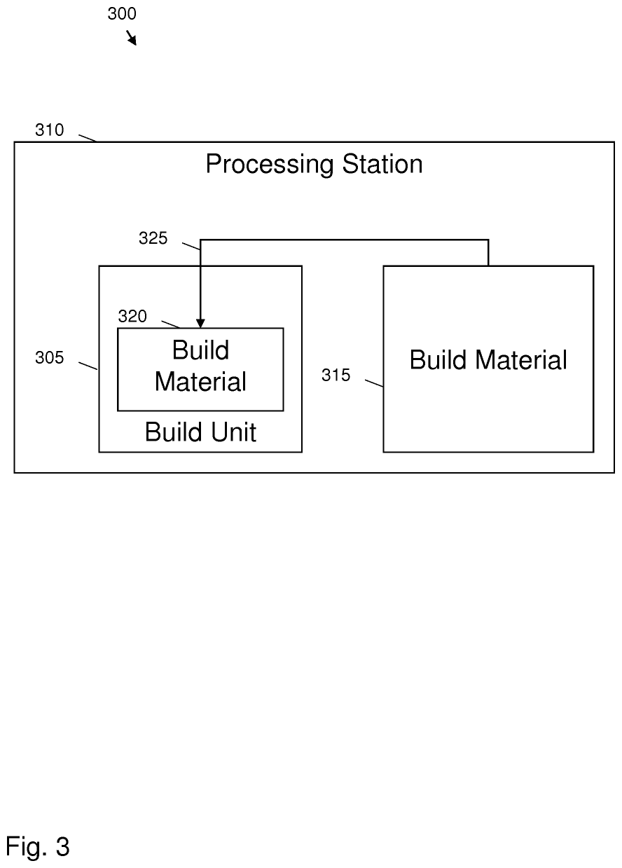

Referring to FIG. 3, there is shown example of part of an additive manufacturing system 300.

In this example, a build unit 305 is located inside a processing station 310. In this example, the processing station 310 includes one or more consumable units 315, for example cartridges, comprising build material. Build material is loaded from the one or more consumable units 315 into one or more building material stores 320 in the build unit 305 as indicated by arrow 325. One or more visible properties of the build material may be identified. For example, a colour and/or level of transparency of the build material may be identified. The build material may have been selected previously, for example by an operator, based on it having a visible property corresponding to a desired visible property of the intended three-dimensional object. For example, build material having a given colour may have been selected to be used to produce a three-dimensional object intended to have the same colour.

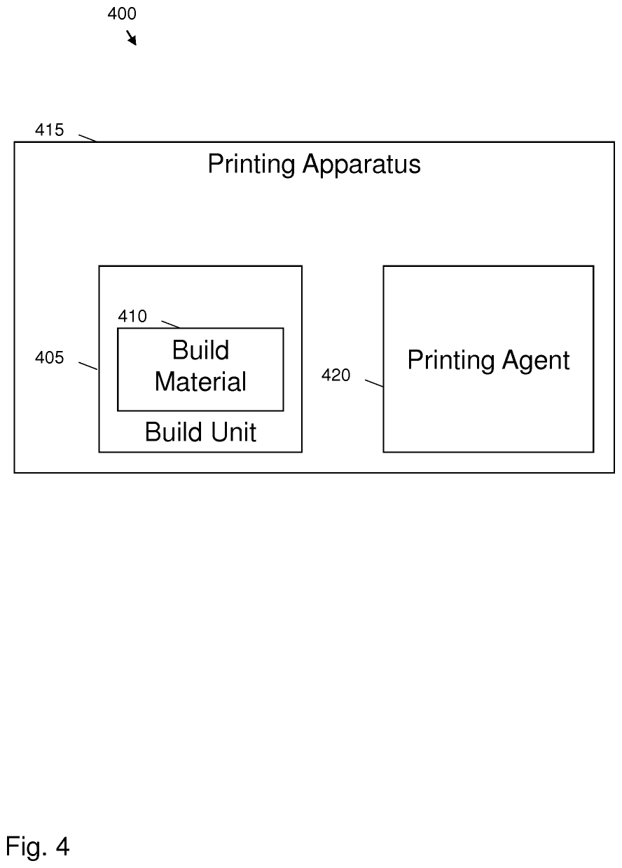

Referring to FIG. 4, there is shown example of part of an additive manufacturing system 400.

In this example, a build unit 405 comprising build material 410 has been moved from a processing station into a printing apparatus 415. The printing apparatus 415 also includes printing agent 420. The printing agent 420 may for example be stored in one or more consumable units, for example cartridges, in the printing apparatus 415. The printing agent 420 may have been selected based on it having one or more given visible properties, for example a given colour and/or level of transparency. The printing agent 420 may have been selected previously, for example by an operator, based on it having a visible property corresponding to a desired visible property of the intended three-dimensional object. For example, a printing agent having a given colour may have been selected to be used to produce a three-dimensional object having the same colour.

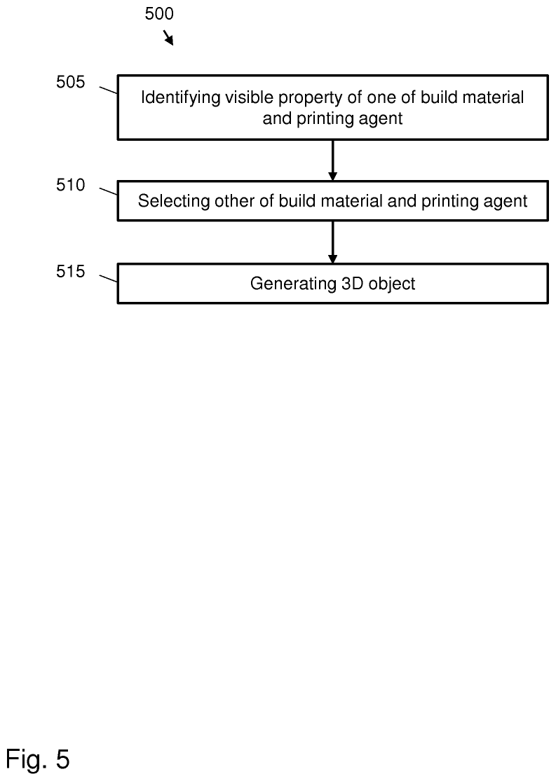

FIG. 5 is a flowchart showing an example of a method 500 of generating a 3D object using a build material and a printing agent. One or more different types of build material and/or one or more different types of printing agent may be used.

The build material and printing agent both have one or more visible properties. Examples of visible properties include, but are not limited to, colour, level of transparency, and colour uniformity of the build material and printing agent. By way of example and not by way of limitation, a visible property of an example build material may be that it is red in colour and a visible property of an example printing agent may be that it is transparent.

At block 505, a visible property of one of the build material and the printing agent is identified. One or more visible properties may be identified. As indicated above, the visible property may, for example, be a colour and/or level of transparency. The identification may be made for example based on one or more desired visible properties of an intended three-dimensional object. For example, where a particular colour is desired for the three-dimensional object, the colour of the one of the build material and the printing agent may be identified. The identification could however be made in a different manner.

In some examples, one or more visible properties of the build material are identified. Where the build material is or comprises powdered material, one or more visible properties of the powdered material may be identified. The one or more visible properties may be identified by an operator, for example by visually inspecting the build material and/or visible property information associated with the build material. The visible property information may for example be on a label on a consumable unit comprising the build material.

In some examples, one or more visible properties of the printing agent are identified. For example, one or more visible properties of a fusing agent and/or a detailing agent may be identified. The one or more visible properties may be identified by an operator and/or control process, for example by visually inspecting the printing agent and/or visible property information associated with the printing agent. The visible property information may for example be on a label on a consumable unit comprising the printing agent.

At block 510, the other of the build material and the printing agent is selected based at least on the other of the build material and the printing agent having a given visible property. The other of the build material and the printing agent may be selected based at least on the other of the build material and the printing agent having one or more given visible properties. As indicated above, the visible property may, for example, be a colour and/or level of transparency.

The build material and printing agent used to generate a three-dimensional object may be selected by an operator. For example, an operator may select build material and printing agent having specific visible properties with knowledge of one or more specific visible properties for a desired three-dimensional object. The operator may select from collection of available build materials and printing agents. For example, there may be a collection of build materials and printing agents of different colours, and build material and printing agent to be used to produce a given 3D object may be selected from that collection, for example based on one or more desired visible properties of the 3D object.

In some examples, the identified visible property is of the build material, for example powdered material, and a printing agent having the given visible property is selected. For example, a fusing agent and/or a detailing agent having the given visible property may be selected. The printing agent having the given visible property may be selected from a group of printing agents where at least one printing agent in the group does not have the given visible property.

In some examples, the identified visible property is of the printing agent and a build material having the given visible property is selected. The build material having the given visible property may be selected from a group of build materials where at least one build material in the group does not have the given visible property.

The selecting of the other of the build material and the printing agent is based at least on the identified visible property (of the one of the build material and the printing agent) and the given visible property (of the other of the build material and the printing agent) having a desired visible property relationship. The desired visible property relationship may be defined by model data for the desired three-dimensional object, user input or in another manner.

The desired visible property relationship may correspond to a measure of difference (or ‘distance’) between the identified visible property and the given visible property. The desired visible property relationship may correspond to the measure of difference between the identified visible property and the given visible property being less than a predetermined visible property difference threshold. The predetermined visible property difference threshold may be zero in some examples, in which case the given visible property is the same as the identified visible property. In other examples, described in more detail below, the predetermined visible property difference threshold is non-zero.

The desired visible property relationship may correspond to a measure of colour difference between an identified colour and a given colour. The desired visible property relationship may correspond to a measure of colour difference between the identified colour and the given colour being less than a predetermined colour difference threshold. The measure of colour difference may quantify the degree of closeness or difference between the identified colour and the given colour, as compared to the degree of closeness or difference being determined subjectively.

The measure of colour difference may be based on the Delta E distance metric of the International Commission on Illumination (CIE). In some examples, the predetermined colour difference threshold corresponds to a Delta E value of ten. A Delta E value of ten may provide an acceptable level of uniformity for the final 3D object. In some examples, the predetermined colour difference threshold corresponds to a Delta E value of five. A Delta E value of five may provide a more acceptable level of uniformity for the final 3D object, where non-uniformity is more difficult to perceive. In some examples, the predetermined colour difference threshold corresponds to a Delta E value of one. A Delta E value of one may provide an even greater level of uniformity for the final 3D object, where any non-uniformity may not be perceptible to the human eye. Other metrics for determining the desired visible property relationship may be used and may have values corresponding to associated Delta E values. Examples of other metrics include, but are not limited to, Delta L, Tstatus and saturation.

At block 515 of FIG. 5, a 3D object is generated using the one of the build material and the printing agent having the identified visible property and the other of the build material and the printing agent having the given visible property. For example, the 3D object may be generated using build material having the identified visible property and print agent having the given visible property, or using build material having the given visible property and print agent having the identified visible property.

In some examples, the selecting of the other of the build material and the printing agent is based on one or more further factors. In some examples, the selecting is based further on a desired visible property for the 3D object. The desired visible property may be a desired colour for the 3D object. The desired visible property may be a desired colour uniformity. For example, it may be desired to generate a 3D object having a first colour using a build material having a second colour. If the second colour is the same as the first colour, a transparent printing agent could be selected for producing the 3D object. If the second colour is different from the first colour, a printing agent having a third, different colour could be selected so that the combination of the build material having the first colour and the printing agent having the third colour results in a 3D object having the second colour.

As such the additive manufacturing system 100 may a build material and a printing agent with given visible properties to generate (or ‘produce’) a 3D object having one or more desired visible properties.

As described above, the additive manufacturing system 100 may have one or more heat sources 120, for example one or more heating lamps, and one or more separate fusing lamps. Heating and fusing energy levels may be adapted to account for the process window associated with the particular combination of build material and printing agent being used. For example, the chemical compositions of the build material and/or printing agent being used may be considered. This may provide the ability to handle colored build materials keeping the process selectivity window. The one or more heat sources 120 may be used in a closed loop to control the temperature of the base. As indicated above, one or more fusing lamps may be used to fuse a selected part. An infrared pigment may be added to the fusing agent to make the fusing agent more reactive to the one or more fusing lamps, thereby improving selectivity.

In some examples, coloured build material, for example coloured powder material, is used to produce coloured parts.

In some examples, a coloured printing agent, for example coloured fusing agent and/or coloured detailing agent, is used to produce coloured parts. As indicated above, this may result in coloured parts with an improved look. The coloured part may have a single colour.

Using the same colour for the build material and the fusing agent improves colour uniformity of the final 3D object since build material, for example powder, sintered on the surface of the 3D object is the same colour as that of the fusing agent. Using the same colour for the build material and the detailing agent improves accuracy in producing the 3D object, while assisting with color uniformity.

In some examples, a transparent printing agent, for example fusing agent and/or detailing agent, is used to produce coloured parts.

The build material and printing agents may be combined so as to achieve a final desired color or other type of visual finish for the 3D object. The 3D object may be produced in a range of colours inside the gamut provided by the build material and printing agent combination.

The selection of the other of the build material and the printing agent may be performed automatically in the additive manufacturing system 100. For example, the additive manufacturing system 100 may be able to determine a desired colour or transparency level for the 3D object, identify a colour or transparency level of available build material (which the additive manufacturing system 100 may have selected based on the desired colour for the 3D object for example) and select a printing agent having a suitable colour or transparency level based at least on these two factors.

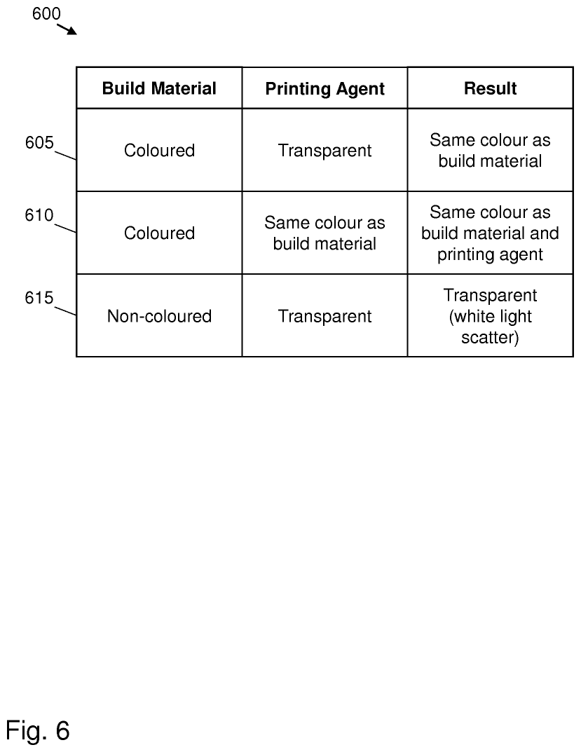

FIG. 6 shows an example of a table 600 depicting different example combinations of build material and printing agent, and corresponding results.

As indicated above, in some examples one or both of the identified visible property and the given visible property is a colour. As also indicated above, in some examples one or both of the identified visible property and the given visible property is a level of transparency.

As indicated by row 605 of table 600, using a coloured build material with a transparent printing agent, results in a 3D object having the same colour as that of the build material.

As indicated by row 610 of table 600, using a coloured build material with a printing agent having the same colour as that of the build material, results in a 3D object having the same colour as that of the build material.

As indicated by row 615 of table 600, using a non-coloured (transparent) build material with a transparent printing agent, results in a transparent 3D object with white light scatter.

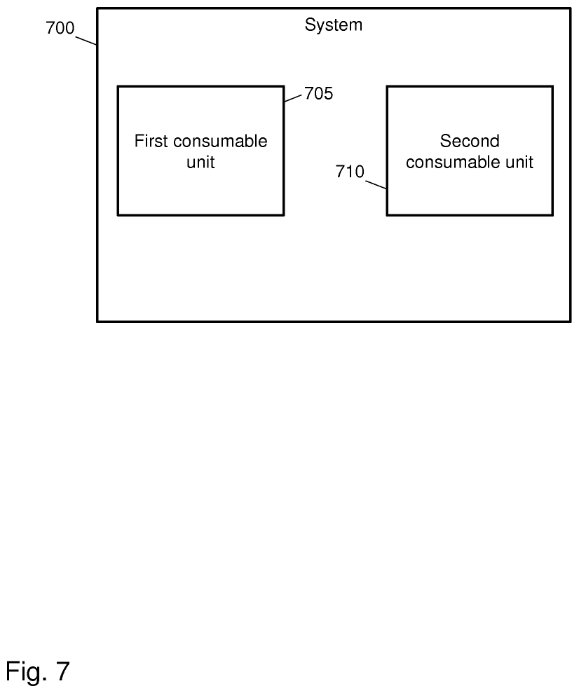

FIG. 7 shows an example of a system 700 comprising a plurality of consumable units. In this example, the system 700 comprises two consumable units, but a different number of consumable units, for example one, three or more, could be provided in other examples. The system 700 may be used in the example additive manufacturing system 100 described above. In this example, a build material is stored in a first consumable unit 705 of the plurality of consumable units and a printing agent is stored in a second consumable unit 710 of the plurality of consumable units. A visible property of one of the build material and the printing agent having the identified visible property has been identified and the other of the build material and the printing agent has been selected based at least on it having a given visible property. The selection has been based on at least the identified visible property and the given visible property having a desired visible property relationship. Instead of the system 700 comprising a plurality of consumable units, in some example the system 700 comprises one consumable unit, for example with the one consumable unit having partitions or reservoirs for the build material and printing agent respectively.

The system 700 may be used to store one or more types of build material and/or one or more types of printing agent 710. For example, the system 700 may comprise a first consumable unit to store build material, a second consumable unit to store a fusing agent (a type of printing agent) and a third consumable unit to store a detailing agent (a type of printing agent).

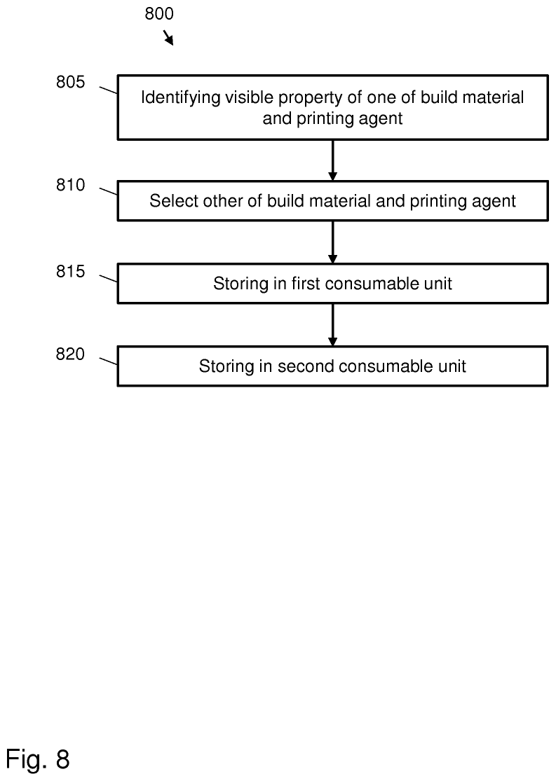

FIG. 8 is a flowchart showing an example of a method 800 of manufacturing a system comprising a plurality of consumable units useable in an additive manufacturing system.

At block 805, a visible property of one of the build material and the printing agent is identified.

At block 810, the other of the build material and the printing agent is selected based at least on the other of the build material and the printing agent having a given visible property. The selecting is also based at least on the identified visible property and the given visible property having a desired visible property relationship.

At block 815, the one of the build material and the printing agent having the identified visible property is stored in a first consumable unit of the plurality of consumable units.

At block 820, the other of the build material and the printing agent having the given visible property is stored in a second consumable unit of the plurality of consumable units. As described above, the system may comprise more than two consumable units.

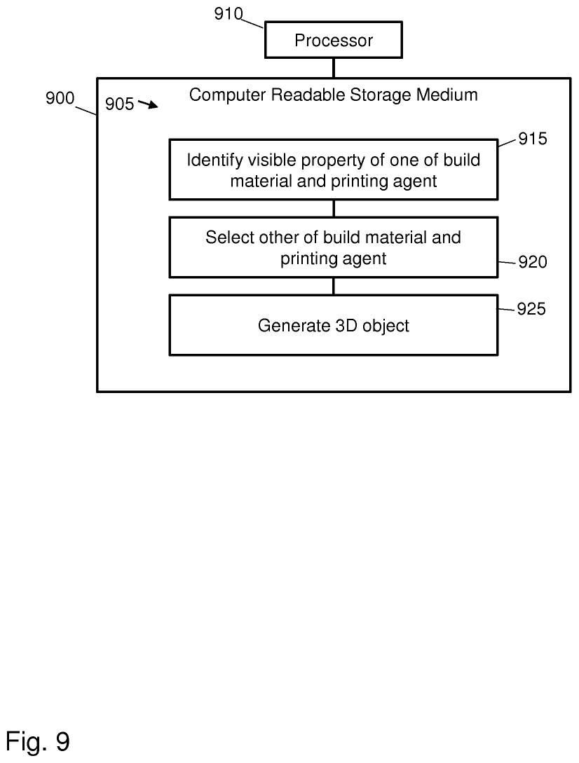

FIG. 9 shows an example of a non-transitory computer-readable storage medium 900 comprising a set of computer readable instructions 905 which, when executed by at least one processor 910, cause the processor 910 to perform a method according to examples described herein. For example, the processor 910 may form part of the controller 125 in FIG. 1. The computer readable instructions 905 may be retrieved from a machine-readable media, e.g. any media that can contain, store, or maintain programs and data for use by or in connection with an instruction execution system. In this case, machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc.

In an example, instructions 905 cause the processor 910 to, at block 915, identify a visible property of one of a build material and a printing agent.

At block 920, instructions 905 cause the processor 910 to select the other of the build material and the printing agent based at least on the other of the build material and the printing agent having a given visible property. The selecting is based at least on the identified visible property and the given visible property having a desired visible property relationship.

At block 925, the instructions 905 cause the processor 910 to, based on the comparison, generate a three-dimensional object using the one of the build material and the printing agent having the identified visible property and the other of the build material and the printing agent having the given visible property.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A method of generating a three-dimensional object using a build material and a printing agent, the method comprising:
identifying a visible property of one of the build material and the printing agent;
selecting the other of the build material and the printing agent based at least on the other of the build material and the printing agent having a given visible property; and
generating a three-dimensional object using:
the one of the build material and the printing agent having the identified visible property; and
the selected other of the build material and the printing agent having the given visible property,
wherein the selecting is based at least on the identified visible property and the given visible property having a desired visible property relationship.

2. A method according to claim 1, wherein the identified visible property is of the build material and the given visible property is of the printing agent.

3. A method according to claim 1, wherein the identified visible property is of the printing agent and the given visible property is of the build material.

4. A method according to claim 1, wherein the selecting is based further on a desired visible property for the three-dimensional object.

5. A method according to claim 1, wherein the printing agent comprises a fusing agent.

6. A method according to claim 1, wherein the printing agent comprises a detailing agent.

7. A method according to claim 1, wherein one or both of the identified visible property and the given visible property is a colour.

8. A method according to claim 7, wherein the desired visible property relationship corresponds to a measure of colour difference between the identified colour and the given colour being less than a predetermined colour difference threshold.

9. A method according to claim 8, wherein the predetermined colour difference threshold corresponds to a Delta E value of ten.

10. A method according to claim 8, wherein the predetermined colour difference threshold corresponds to a Delta E value of five.

11. A method according to claim 8, wherein the predetermined colour difference threshold corresponds to a Delta E value of one.

12. A method according to claim 1, wherein a colour of the one of the build material and the printing agent is the same a colour of the other of the build material and the printing agent.

13. A method according to claim 1, wherein one or both of the identified visible property and the given visible property is a level of transparency.

14. Apparatus to generate a three-dimensional object using build material and one or more printing agents, the apparatus being arranged to:
identify one or more visible properties of one of the build material and the one or more printing agents;
select the other of the build material and the one or more printing agents based at least on the other of the build material and the one or more printing agents having one or more predetermined visible properties; and
produce a three-dimensional object using:
the one of build material and the one or more printing agents having the one or more identified visible properties; and
the selected other of the build material and the one or more printing agents having the one or more predetermined visible properties,
wherein the apparatus is arranged to select the other of the build material and the one or more printing agents based at least on the one or more identified visible properties and the one or more predetermined visible properties having one or more desired visible property relationships.

15. A method of manufacturing a system comprising a plurality of consumable units useable in an additive manufacturing system, the method comprising:
identifying a colour of one of the build material and the printing agent;
selecting the other of the build material and the printing agent based at least on the other of the build material and the printing agent having a given colour; and
storing the one of the build material and the printing agent having the identified colour in a first consumable unit of the plurality of consumable units; and
storing the selected other of the build material and the printing agent having the given colour in a second consumable unit of the plurality of consumable units,
wherein the selecting is based at least on the identified colour and the given colour having a desired colour relationship.
